(19) United States
(12) Patent Application Publication
(10) Pub. No.: US 2025/0073718 A1
(43) Pub. Date: Mar. 6, 2025

(54) SAMPLE CONTAINER THAT CAN BE CLOSED WITH A NONWOVEN FABRIC, USE OF THE SAMPLE CONTAINER FOR DRYING AND PROCESSING THE SAMPLE OF A BIOLOGICAL MATERIAL, AND METHOD FOR PROCESSING THE SAMPLE

(71) Applicant: ABF DIAGNOSTICS GMBH, Kranzberg (DE)

(72) Inventor: Franz Aberl, Kranzberg (DE)

(21) Appl. No.: 18/029,017

(22) PCT Filed: Sep. 28, 2021
(86) PCT No.: PCT/EP2021/076670

§ 371 Date: Mar. 28, 2023

(30) Foreign Application Priority Data
Sep. 29, 2020 (DE) 10 2020 212 266.0

(51) Int. Cl. B01L 3/00

(52) U.S. Cl. CPC B01L 3/5029; B01L 3/50825; B01L 2200/141; B01L 2300/042; B01L 2300/048

(57) ABSTRACT

A closable sample container with closure device, suitable for transporting and storing biological material, the use of the sample container for drying and processing a sample of the biological material and to a method for processing the sample of the biological material using the sample container.

The present invention relates to a closable sample container with closure device, suitable for transporting and storing biological material. In addition, the present invention relates to a container, by which further processing of the biological sample within the same container likewise is made possible. Furthermore, the present invention relates to the use of the sample container for drying and processing the sample of a biological material and to a method for processing the sample of a biological material.

### PRIOR ART

The importance of biological sample materials is steadily increasing in many areas of analytics. This applies in particular to the fields of forensics, medicine, microbiology and parentage assessment. Since biological samples generally tend to degrade and become instable, the methods respectively used for sample collection, for sample preservation, for sample transport and for sample processing are essential for an exact and accurate determination of a biological analyte.

Particularly interesting are biological sample materials that are easily accessible and contain large amounts of nucleic acid containing material. Sample materials that fulfill these requirements in a particular way are buccal swabs and saliva samples.

These materials are often gained by simple abrasion of the buccal mucosa. As the collection is noninvasive and can be done under sight, the sample material is difficult to manipulate and is to be collected without a risk of contamination. So-called drop swabs are employed particularly frequently in this context, where the swab head can be separated from the stem by mechanically pushing it off and transferred to a tube and breaking or cutting off the swab head containing the biological sample is not required. After collection of the sample it is transferred to a laboratory for processing. In so doing it has to be ensured that the sample is not degraded prior to further processing, neither during transport nor during storage.

For further processing a buccal swab, for example, the method of Chelex extraction described by Walsh et al. (Biotechniques, 10 (4) 506-513) can be used. In this method, after collection of the sample, the swab head is mixed with a polymer solution and incubated at a temperature of 56° C. for a longer period of time. The polymer particles contained in the solution support the lysis of the buccal swab and prevent degradation of the biological sample during sample digestion. After lysis, the polymer particles are centrifuged and the supernatant is further analyzed.

An alternative method for lysis of buccal swab samples is based on the incubation of the obtained cell material with a denaturing detergent (e.g. SDS, Triton-X-100) with the addition of proteinase K. Proteinase K hydrolyzes proteins and attacks the cell wall and DNA-binding proteins, resulting in the release of DNA. Common to those digestion processes is the addition of a fluid (liquid), in particular an aqueous solution, to the sample to be examined.

Further methods of sample processing are described in literature and are well-known to a person skilled in the art.

A frequently used method for the preservation of a biological sample is drying under controlled conditions. In the prior art containers are used which are either covered with a semipermeable membrane or which contain an integrated drying agent or desiccant. In the first case, the semipermeable membrane allows moisture to evaporate from a swab head and the escape of the water vapor from the container.

The disadvantage of this process is that drying is very slow due to the often low permeability of membranes. In contrast, an integrated drying agent leads to accelerated drying, however, such containers are difficult to manufacture and therefore expensive. In both cases the biological samples are removed from the receiving or transport containers in the laboratory and transferred to new reaction vessels for further processing.

Patent specification DE 10 2007 006 505 describes various embodiments of a swab for obtaining a biological sample which, due to its special design, achieves drying and thus preservation of a moist sample in a special transport tube. For this purpose, the housing of the transport tube is provided with one or more pores through which moisture can escape from the sample. To protect the sample inside the transport tube from unintentional contamination, the pore openings are filled with a membrane permeable to water vapor.

Disadvantages of this invention are that the dry sample must first be transferred to a reaction vessel in the laboratory before it can be digested and purified. The transfer of the samples can be done by breaking off or cutting off. This is time-consuming, especially in screening tests, and involves the risk of unwanted contamination. Furthermore, there is the risk of unintentional sample mix-up when transferring the samples from the transport container to the reaction vessel intended for sample processing.

Furthermore, this document describes a container that, due to its design, allows drying and preservation of a moist or wet sample once it was placed in the container. For this purpose, the wall of the transport tube is provided with one or more pores through which moisture can escape. To protect the sample from accidental contamination, the pore openings again are filled with a membrane permeable to water vapor. This device likewise has the disadvantage that the dry sample first has to be transferred to a suitable reaction vessel in the laboratory before it can be further processed.

DE 60 2004 008 884 relates to a device for the storage and transport of forensic and/or biological material, which comprises a closable tubular container and a swab for receiving and storing the sample. The swab is connected to the closing cap of the container, which hermetically seals the container. One or more ventilation holes are inserted in the container wall, which are closed when not in use. After introducing a moist sample into the container, the closure is removed from the ventilation holes and the ventilation holes are uncovered so that the sample material can dry again in the air while remaining inside the container, thus being protected from contamination.

The systems described in DE 10 2008 035 851 A1 and WO 2011106784 A1 achieve drying of a moist, biological sample by means of a drying agent which is integrated directly into the transport tube and is arranged in such a way that it encloses the cotton head with the sample as far as possible. This ensures highly efficient drying of the sample, but here too, the sample has to be transferred to another reaction vessel after drying and transport to the laboratory. At the same time, the complex design of the swab results in high manufacturing costs. Since the drying agent introduced is not arranged transparently around the head of the swab, there is also the risk that unintentional contact between the head of the swab and the tube wall can lead to loss of the sample.

In documents US 2014/0105796 A1 and US 2020/0094248 A1, a transport container for biological samples is described, in the closure device of which a drying agent is contained. After the buccal swab, the head of the swab is introduced into the transport container and, after closure, can dry in the transport container. The use of a drying agent in the transport container makes sample processing directly in the transport container impossible and for further analyses, the swab head must be transferred to a suitable reaction vessel, which in turn is associated with the disadvantages mentioned above.

Finally, document U.S. Pat. No. 6,171,260 B1 describes the use of a box of cardboard material for drying, preservation and transport of biological samples. The outer carton serves both as a storage and transport container. After swabbing, the entire cotton swab is fixed in a special holding device in the cardboard box. The holding device ensures that the swab head does not come into contact with the cardboard walls. Since cardboard boxes are generally permeable to moisture, drying and preservation of the sample in the transport box is ensured. After receipt of the sample in the laboratory, the swab is removed from the outer packaging, the swab head is separated from the stem of the swab and transferred into a reaction vessel for further processing.

However, the sample drying methods known from the prior art, as well as the containers used for this purpose, are susceptible to various defects. In particular, such containers which allow drying of the sample, in principle are not adequately protected against leakage of fluids through the membrane or contamination from the outside.

Although, according to the prior art, the biological sample is dried in the transport container and thus is preserved and in part protected from contamination, it must be removed from the transport container after arrival in the laboratory and transferred to a suitable reaction vessel.

This process is time-consuming and involves a high risk of sample contamination. There is also a risk of confusion of the samples during the transfer process. Finally, the use of two containers (transport container and reaction container) significantly increases material consumption.

In other words, there currently is no container that allows a biological sample not only to be preserved to make it suitable for storage or transport, but that also enables processing of such sample within the same vessel at the same time, which so far has entailed an increased risk of contamination, high material consumption, and a risk of confusion in this sensitive area.

### SUMMARY OF THE INVENTION

It is the object of the invention to avoid or at least reduce at least one disadvantage of the prior art and in particular to provide a device and a method which enables safe transport and safe storage of a sample of biological material and also ensures safe and efficient processing of the biological sample.

Specifically, the object is solved by a closable container with a closure device and an opening that is closable by the closure device, suitable for transport and storage of biological material, and with at least one further opening through the wall of the closable container and/or the closure device, characterized in that at least one of the openings is closed or covered with a nonwoven fabric. Those features likewise enable, in addition to storage and drying of the biological sample within the container, processing of the sample within the container by way of the opening closed with a nonwoven fabric.

In particular, an advantage of the invention in this regard is to simplify the process of processing by ensuring that processing of the biological sample can take place within the same container. This process, in addition to simplifying the process, since only one container and no longer two different ones are required, also is to decrease the risk of contamination for the sample. Since the biological sample no longer has to be removed from the container for further processing, the risk of contamination being carried to the sample from the outside is reduced.

In particular, another advantage of the invention also is to reduce the costs of the method, as well as the waste produced, since the method merely makes use of a single container for transport and preparation.

Furthermore, a faster and less expensive process of the method is ensured as time is saved by avoiding an intermediate step, i.e. the transfer of the biological sample into a reaction vessel. This step is particularly difficult to automate and is still carried out manually even in large numbers of samples.

A further advantage of the invention is that by omitting transfer of the sample, confusion of samples or an error in labeling the samples is avoided.

The nonwoven fabric is thereby designed to form a barrier for biological material, and is preferably characterized by preventing biological material from entering the inside. Such a barrier ensures protection against contamination of the biological sample inside the container.

Moreover, the nonwoven fabric is characterized in that it allows steam, in particular water vapor, to pass from the inside to the outside. This property enables fast and efficient drying of the sample inside the container and prevents degradation of the sample. The process is essential for the subsequent utilization of the biological sample.

Furthermore, the nonwoven fabric is designed in such a way that it retains fluids (liquids), especially aqueous solutions, inside. This property makes it possible to process the biological sample within the same container. In particular, a lysis fluid for digestion of the biological sample in a first step of the sample analysis, for example by a polymerase chain reaction (PCR), can be introduced into the same container used for the drying process without this fluid escaping to the outside during processing of the sample.

The present invention is based primarily on the finding that nonwoven fabric materials according to the invention provide an excellent combination of permeability to water vapor and retention of fluids (liquids), especially aqueous solutions. The container according to the present invention thus provides a device that allows both storage, drying and processing of biological samples in the same container.

Accordingly, biological samples within the meaning of the present invention include, according to a preferred embodiment, buccal mucosal swabs and/or saliva samples.

However, other sample materials may also include other body fluids or secretions, such as blood, saliva, urine, sweat, tears, semen, vaginal fluids, nasal secretions, or wound fluid. The term biological sample includes both human body materials and animal samples for examination for veterinary, animal forensic or hygienic purposes.

The relevant target analytes in the biological samples include all constituents of biological materials such as nucleic acids, proteins, carbohydrates, lipids, vitamins and all kinds of metabolites.

In the present invention, biological samples containing nucleic acids are understood to be biological samples that contain poly- or oligonucleotides, which are to be collected and made accessible for analytical detection of the contained nucleic acid molecules, for example DNA, RNA, or other types of nucleic acid molecules.

Swabs for obtaining the biological samples consist essentially of a holding element, e.g. a hollow or solid stem or shaft made of wood or plastic, and a sample collection portion for collecting the biological sample, which is located at one end of the holding element.

The material of the sample collection portion is not subject to any special restriction as long as it is suited to receive the biological sample permanently until further processing in the laboratory and then release it again in the course of the analysis during treatment with suitable extraction or reagent solutions.

The sample collection portion may be formed for example of a cotton swab, however, other materials and structures may also be used. Typical swabs have a cotton head consisting of coiled but random cotton fibers.

Preferably, the closure device of the container is either a click or screw-cap. Preferably, such a closure is either firmly connected to the container, detachable or removable.

Preferably, the nonwoven fabric used here can be located on the outside of the cap or on the inside of the cap or on both sides at the same time. Further preferably, the nonwoven fabric can be firmly bonded to the plastic part of the cap with the aid of a welding method.

According to a preferred embodiment, the nonwoven fabric attached to the container has a void volume of more than 30 percent, preferably of more than 50 percent, and/or is composed of hydrophobic organic polymers.

According to the present invention, the void volume Lv in % preferably is thereby determined as follows:

$${L}_{v} = 100 \times ( 1 - G / D / H ) ,$$

the individual parameters being determined as follows:

$${L}_{v} = Void volume in \%$$

$$G = Basis weight [ g / {m}^{2} ]$$

$$D = Thickness of nonwoven material [ cm ]$$

$$H = Density of the fiber material [ g / {cm}^{3} ]$$

In particular, the nonwoven fabric used may be composed, entirely or in part, of one or more of the following materials: Polyester (PES), polyethylene (PE), polypropylene (PP), polytetrafluoroethylene (PTFE), polyvinylidine fluoride (PVDF), polyvinyl chloride (PVC) or polycarbonate.

Preferably, the nonwoven fabric used may be composed, entirely or in part of a suitable polymeric nonwoven fabric of synthetic fibers with hydrophobic properties, preferably polypropylene, polyethylene, polyester or polycarbonates.

In particular, the nonwoven fabric used can have a basis weight according to ISO 9073-1 (issue date 1989-07) of between 20 and 500 g/m², preferably between 50 and 300 g/m².

In particular, the nonwoven fabric used may have an air permeability according to ISO 9073-15 (issue date 2007-07) of between 30 and 4000 dm³/s m², preferably between 80 and 2000 dm³/s m².

In particular, the nonwoven fabric used may have a thickness according to FNS 19-04-04 of between 0.05 and 1.0 mm, preferably between 0.10 and 0.53 mm.

A nonwoven fabric according to the present invention is preferably a sheet-structure of loose fibers, continuous filaments or chopped yams. Nonwoven fabrics are typically classified according to their fiber type, fiber length or orientation. Other classification types are based on the manufacturing method or the field of application.

Nonwoven fabrics are characterized by their large void volume (defined as void volume in relation to total volume), which makes them particularly suitable for technical filtration applications where high throughput is required.

In contrast, the term membrane, as described and applied in the cited prior art, describes a thin structure consisting of a continuous material comparable to a skin or film. In relation to their thickness, membranes have a large areal extent. Typical membrane thicknesses range from 5 to 50 mm.

Only by introducing pores do membranes become permeable to water vapor or other substances. In filtration, membranes with defined pore sizes are used for selectively separating certain components from a solution or a gas phase.

Since membranes are a continuous material with small holes (pores), the void volume is comparatively small compared to the volume of the membrane material (usually less than 20%). The small thickness makes membranes mechanically vulnerable, which in the present technical field increases the risk of contamination.

Hydrophobic properties are important for both nonwoven fabrics and membranes, as the hydrophobicity of the material prevents aqueous solutions from intrusion, or water vapor from accumulating. Water vapor is able to penetrate hydrophobic membranes or nonwoven fabrics without hindrance, while aqueous solutions are repelled and thus well retained within a vessel.

Hydrophilic nonwoven fabrics and membranes have the disadvantage that they have only a low barrier effect against aqueous solutions. Hydrophilic nonwoven fabrics or membranes absorb aqueous samples well and can therefore conduct them well to the outside or also to the inside. For example, during transport of a moist cotton swab contact between the moist biological sample on the swab head and the nonwoven fabric or membrane may occur, and part of the samples may leak to the outside. Conversely, aqueous fluids may also penetrate from the outside to the inside and contaminate the sample.

The sample container according to the present invention is preferably dimensionally stable in such a way that it retains its shape when used according to the invention. In particular, it should not be possible to compress it during use according to the invention, so that no mechanical compressive forces are exerted on the biological sample accommodated therein.

Preferably, the sample container according to the present invention is in the form of a tube, which preferably has a rounded lower section (bottom region). The lower section may moreover be formed to taper conically downwards. In the upper section the closable opening and the closure device are provided. Comparable sample containers in terms of shape are typically referred to as reaction vessels and, in the case of smaller volumes, as micro-reaction vessels, in English also frequently named “Eppendorf tubes”. The volume of the sample container according to the present invention may range from 0.2 to 50 ml, preferably from 0.2 to 25 ml, and more preferably from 0.2 to 10 ml and particularly preferably from 1 to 5 ml.

The sample of a biological material can be collected by means of a swab. If the biological sample is collected by means of a swab and transferred into the sample container according to the present invention, the sample container according to the invention has at least a size sufficient to accommodate the swab head.

In particular, the container may have a length in the range of from 1 to 30 cm, preferably between preferably between 2 and 25 cm, further preferably between 2 and 15 cm. The opening, which is closable by a closure device, can preferably have a diameter of between 0.5 and 3 cm, preferably between 0.5 and 2 cm, further preferably between 1 and 1.5 cm and serves both for the introduction of the biological sample for drying and for the introduction of the lysis fluid for processing the same.

If the sample container according to the invention also is intended to be used for processing the biological sample introduced therein and, in the process, a fluid (liquid) is introduced into the container, it is advantageous according to a preferred embodiment that the at least one further opening, which is closed or covered with a nonwoven fabric, is formed in a region that is above the fluid level during processing. In particular, in a sample container in which the opening closable by a closure device is provided at the upper end, the at least one further opening is formed only in the upper half, preferably only in the upper third, of the sample container according to the present invention. In this case, the lower half, or the lower two thirds, of the sample container is/are free of any opening.

According to a particularly preferred embodiment, the at least one further opening, which is closed or covered with a nonwoven fabric, is formed in the closure device, i.e. through the closure device.

Manufacture of the container according to the invention can be performed in a manner known to the skilled person using a number of established production technologies. For cost reasons, the container consists of only a small number of components, each of which is simple and inexpensive to manufacture and can then be assembled in a few simple steps.

For manufacturing the plastic parts, prior art manufacturing processes such as injection molding, extrusion or deep-drawing can be used. In those processes, plastic parts can be manufactured with high dimensional accuracy in large quantities and at low costs.

The nonwoven fabrics to be utilized are commercially available and may consist of various materials and material mixtures. Processing can be done by cutting or punching or laser cutting.

The application of nonwoven fabrics to plastic parts is known from the prior art and is usually carried out with the aid of welding processes, in which the plastic part and the nonwoven fabric are fused together. The required melting energy can be supplied by ultrasound or heating.

Typically, the individual parts are manufactured in a clean room under controlled conditions and, if necessary, are additionally sterilized before assembly.

Assembly of the individual parts likewise is performed in a clean room under controlled conditions or at a laminar flow workstation with suitably filtered air.

All embodiments of the present invention described herein are deemed as being combinable with each other, unless the person skilled in the art considers such a combination as not to be technically useful.

### BRIEF DESCRIPTION OF THE FIGURES

Further advantages and features of the present invention will become apparent from the description of the embodiments as well as from the drawings or figures in which

FIGS. 1.1-1.5 show different swabs according to the prior art.

FIGS. 2.1-2.3 are a schematic representation of various reaction vessels according to the prior art as are used today in a laboratory for processing biological samples.

FIGS. 3.1-3.3 are a schematic representation of one type of reaction vessel, in the interior of which various swab heads are located.

FIGS. 4.1-4.3 are a schematic representation of various embodiments of the device according to the present invention with a nonwoven fabric in the closure device of the transport container that is permeable to water vapor. The nonwoven fabric permeable to water vapor can be situated on the outside (FIG. 4.1), the inside of the closure device (FIG. 4.2) or on both sides (FIG. 4.3).

FIGS. 5.1-5.3 are a schematic representation of various embodiments of the device according to the present invention using the example of an alternative reaction vessel. The nonwoven fabric permeable to water vapor can be situated on the outside (FIG. 5.1), the inside of the closure device (FIG. 5.2) or on both sides (FIG. 5.3).

FIGS. 6.1-6.3 are a schematic representation of the drying process of a buccal swab in the device according to the invention. Due to the permeability to water vapor of the nonwoven fabric used, the sample dries in the transport container and thereby prevents undesired degradation of the sample.

FIGS. 7.1-7.3 are a schematic representation of sample digestion in the laboratory. The swab heads are exposed to a lysis solution in the transport container (without any further handling steps) and incubated at an elevated temperature. Due to its diffusion resistance, the nonwoven fabric used prevents excessive evaporation of the lysis fluid.

FIGS. 8.1-8.3 are a schematic representation of an embodiment of the device of the invention with an additional diffusion barrier on the nonwoven fabric. The nonwoven fabric is located on the outside of the closure device.

FIGS. 9.1-9.3 are a schematic representation of an embodiment of the device of the invention with an additional diffusion barrier in the closure device of the transport device. The nonwoven fabric is located on the inside of the closure device.

FIG. 10 shows the drying behavior of a swab head in the device according to the invention depending on the type of closure.

FIG. 11 shows the loss of lysis fluid during the lysis process.

### EMBODIMENT

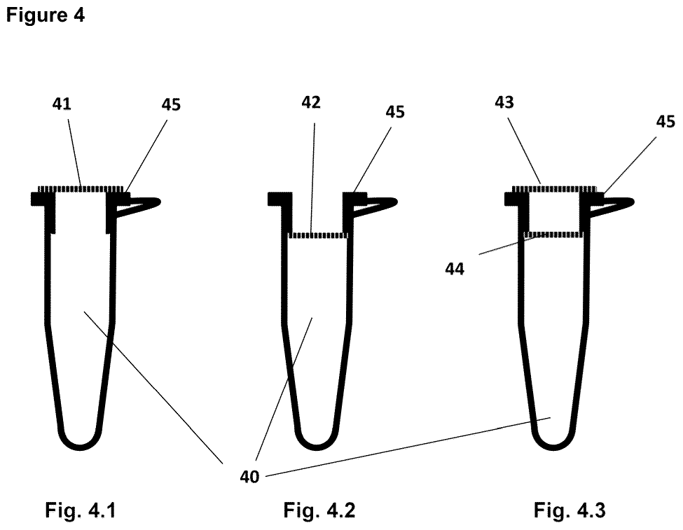

The subsequent description of the embodiment is based on FIG. 4.1.

For manufacturing the container according to the invention Eppendorf Safelock reaction vessels were used as an example. An opening with a diameter of 7 mm was punched centrally into the cap. On the remaining cap ring, a round polyester nonwoven fabric with a diameter of 12 mm was attached. For the production of small batches the nonwoven fabric can preferably be glued on with double-sided adhesive tape. For larger series the nonwoven fabric can preferably be thermally welded to the cap material. An attachment of the nonwoven fabric to the cap ring by ultrasonic welding or bonding is also possible.

Polyester nonwoven fabrics of the company Freudenberg (H1010, H1015 and H1030) have been utilized as nonwoven fabric materials up to now.

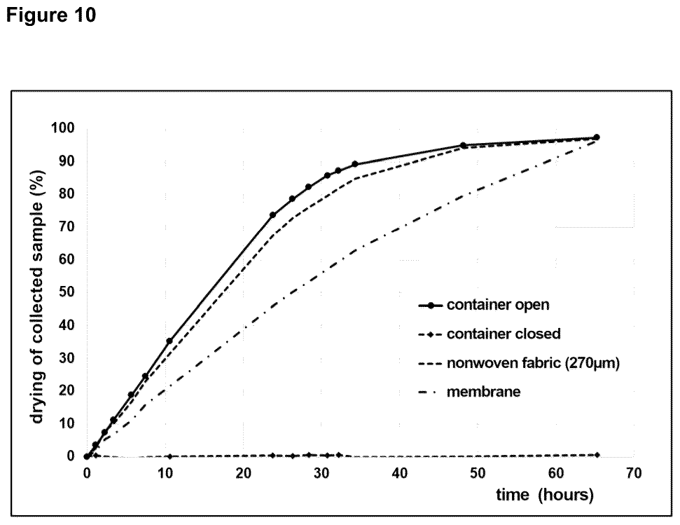

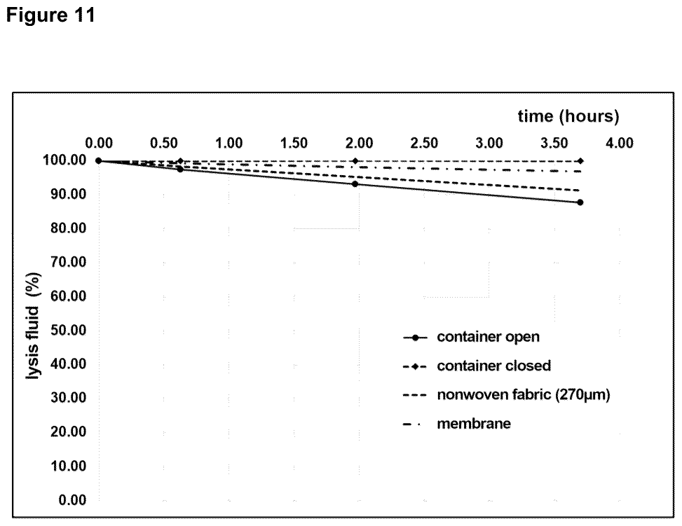

The experiments described in FIGS. 10 and 11 refer to the aforementioned nonwoven fabrics of Freudenberg.

### Detailed Description of Preferred Embodiments

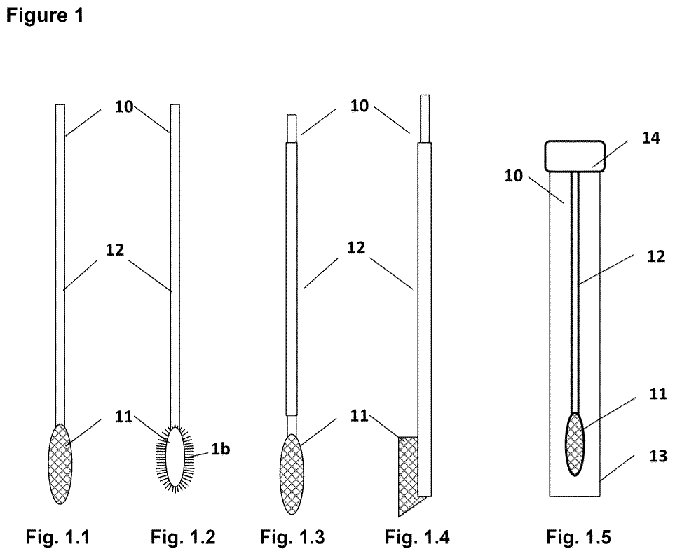

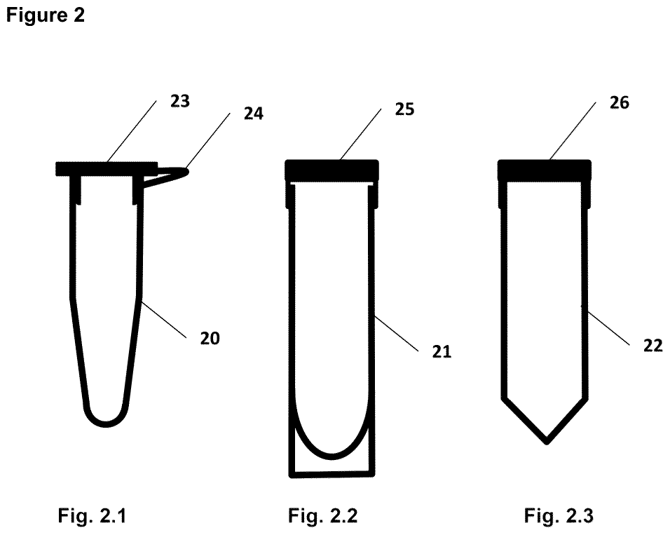

For comparison with the present invention, FIGS. 1 and 2 first show prior art swabs and reaction vessels. Here, the various swabs 10 comprise a stem 11 and a sample collection portion 12. The sample collection portion may be in the form of a coiled swab (FIGS. 1.1, 1.3 and 1.5), a flocked swab or a comb (FIG. 1.4).

To protect the sample against contamination, the swab can be built into a transport tube 13. In this case, the swab is firmly connected to the closure 14. Particularly advantageous for buccal swabs are swabs with detachable head (FIGS. 1.3 and 1.4).

Transport containers for receiving the swab are known in the prior art. These are usually containers in the form of a test tube, also referred to below as transport tubes. Usually, the transport tube according to the present invention is substantially made of plastic material, preferably a transparent plastic material. Suitable transport tubes usually have a length in the range of 10 to 25 cm, for example 12 to 20 cm, and a diameter in the range of 1 to 2 cm, for example, 1 to 1.5 cm.

Swabs, also known as cotton swabs or brushes, generally consist of an elongated, rod-shaped handle that has a sample collection portion at one end and a holding portion at the other end. For the collection of biological samples outside a laboratory or when analysis of the sample can only be performed with a certain time delay, such swabs are combined with a transport tube, the holding portion then also forming the closure of the transport tube.

For a buccal swab the swab 10 is rubbed over the inside of the cheek and the swab head is transferred to a reaction vessel by breaking or cutting. For the swabs with detachable swab head as shown in FIGS. 1.3 and 1.4, the swab head can simply be stripped off.

FIG. 2 shows typical reaction vessels for the processing of a buccal swab. FIG. 2.1 shows a reaction vessel with attached cap, in which the cap is connected to the reaction vessel 20 via a hinge 24. FIGS. 2.2 and 2.5 illustrate screw-cap vessels, once with a stand-up bottom and once with a pointed bottom. The reaction vessels shown are characterized in that the vessel (20, 21, 22) can be sealed moisture-tight by the cap (23, 25, 26).

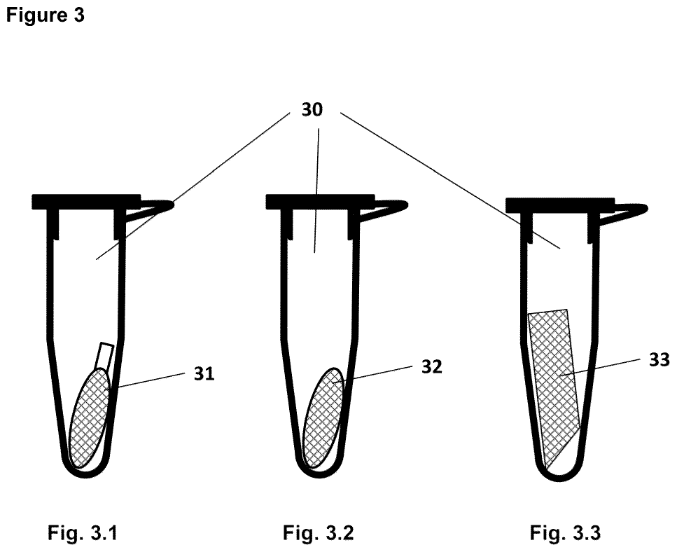

FIG. 3 shows an example of the reaction vessel from FIG. 2.1 with the swab heads 31, 32 and 33 of the swabs from FIGS. 1.1, 1.3 and 1.4. The cap 34 closes the vessel 30 in a moisture- and gas-tight manner.

FIG. 4 shows schematically various embodiments of a device 40 according to the present invention. The cap 40 is provided with an opening, this opening being covered with a moisture-permeable nonwoven fabric.

The nonwoven fabric can be situated either on the outside of the lid (FIG. 4.1) or on the inner cap edge (FIG. 4.2) or on both sides simultaneously (FIG. 4.3).

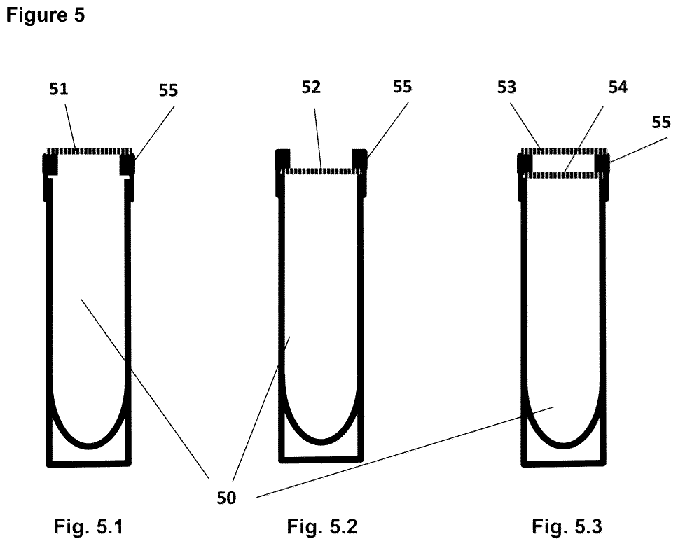

FIG. 5 shows another embodiment of the device according to the invention similar to FIG. 4, but not with a plug-in cap but with a screw-cap 50. Here again there are the options that the nonwoven fabric is situated on the outside of the cap (FIG. 5.1) or on the inner edge of the cap (FIG. 5.2) or is attached on both sides (FIG. 5.3).

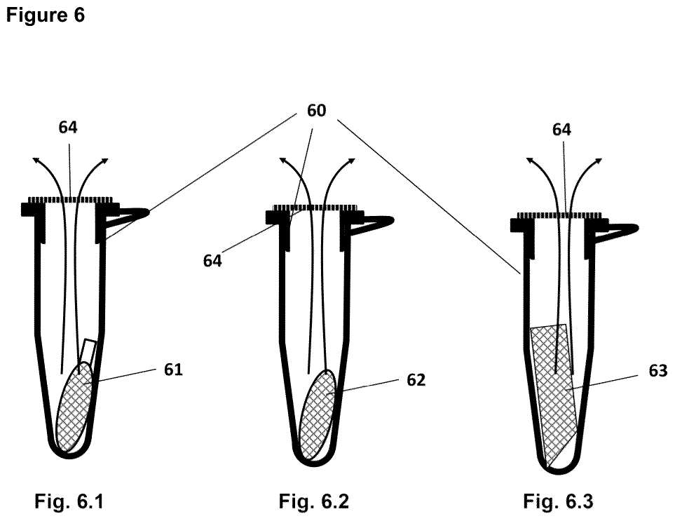

FIG. 6 schematically shows the drying of various swab heads in the reaction vessel with drying nonwoven fabric from FIG. 4.1. Since the applied nonwoven fabric is permeable to moisture, moist swab heads dry within a short time inside the vessel without being exposed to the risk of undesirable contamination. The biological sample with its DNA remains intact and can be transported to the laboratory and stored with the aid of the device according to the present invention.

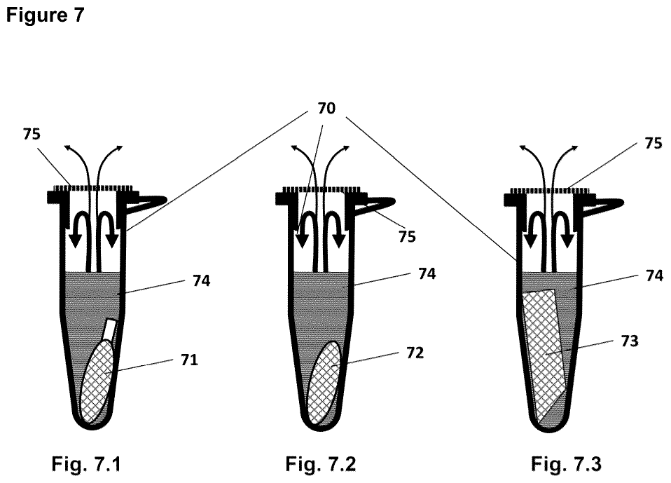

FIG. 7 schematically shows the situation after introducing a lysis fluid 74 into the device according to the invention. The vast proportion of the lysis fluid is retained by the applied nonwoven fabric 75, and lysis of the biological sample on the swab heads 71, 72 or 72 can be carried out safely.

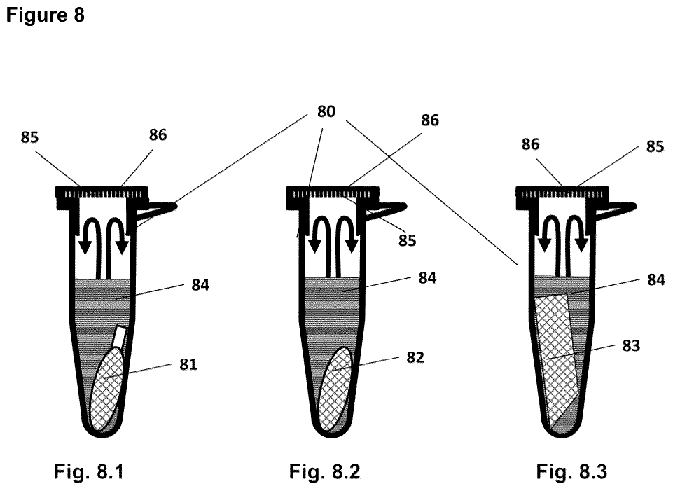

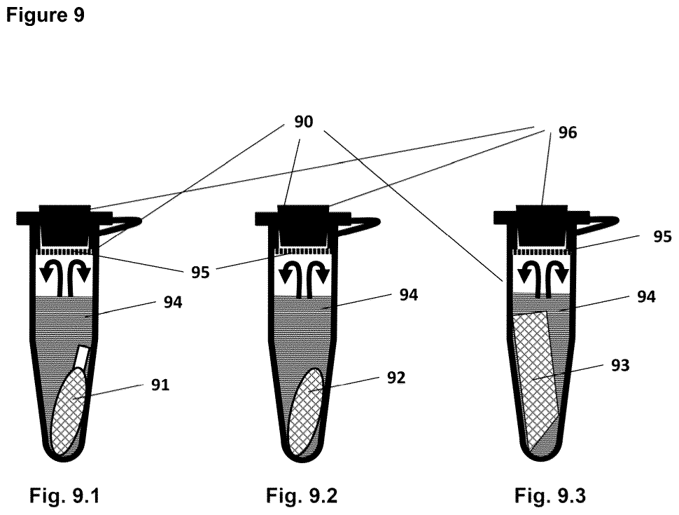

FIGS. 8.1-8.3 and 9.1-9.3 show further variants of the device according to the invention. If it is desired to completely prevent evaporation of the lysis fluid, the nonwoven fabric 85 can be sealed by an additional cover 86 (FIG. 8) or an additional plug 90 (FIG. 9).

FIG. 10 shows the typical course of drying of moistened swab heads in the device according to the invention in comparison with prior art devices. Depending on the closure material, the swab head dries at different rates. These experiments were conducted at a temperature of 2° C. and an ambient humidity of 60 percent.

These tests show that a container with a nonwoven fabric of a thickness of 270 μm according to the invention ensures excellent drying, which is almost equal to drying in an open container. In contrast, drying in a container covered with a membrane such as Goretex® (PTFE film with pores), Sympatex® (film consisting of a copolymer with 70% of polyester and 30% of polyether with pores) or Tyvek® (film consisting of HDPE), as used in the prior art, is significantly slower.

FIG. 11 shows the fluid loss during incubation of the swab heads in transport vessels with different closure variants in accordance with the prior art or the present invention.

The transport vessels were filled with lysis fluid and incubated for several hours at 56° C. Even after several hours of incubation, the fluid loss is less than 10 percent, which can be assumed as not to negatively influence the course of the lysis reaction.

Thus, a container according to the present invention possesses excellent properties for drying biological samples while at the same time providing protection from contamination and suitability for processing the sample in the same container due to a barrier to fluid loss during processing.

1.-14. (canceled)

15. A closable sample container with a closure device and an opening closable by the closure device, suitable for transport and storage of a sample of biological material, and having at least one further opening through the wall of the closable container and the closure device, characterized in that at least one of the openings is closed or covered with a nonwoven fabric.

16. The closable sample container of claim 15, characterized in that the nonwoven fabric is designed so as to form a barrier for a biological material, thereby preventing the biological material from entering an inside of the container.

17. The closable sample container of 15, characterized in that the nonwoven fabric is designed so as to allow steam in the form of water vapor to pass from the inside to an outside.

18. The closable sample container of claim 15, characterized in that the nonwoven fabric is designed so as to form a barrier for fluids, and thereby retains fluids inside of the container.

19. The closable sample container of claim 15, characterized in that the nonwoven fabric is situated on the outside of the closure device, on the inside of the closure device or on both sides.

20. The closable sample container of claim 15, characterized in that the nonwoven fabric has a void volume of more than 30 percent and is composed of hydrophobic organic polymers.

21. The closable sample container of claim 15, characterized in that the nonwoven fabric to be used is comprised, at least in part, of one or more material selected from the group comprising polyester (PES), polyethylene (PE), polypropylene (PP), polytetrafluoroethylene (PTFE), polyvinylidine fluoride (PVDF), polyvinyl chloride (PVC) or polycarbonate.

22. The closable sample container of claim 15, characterized in that the nonwoven fabric used is comprised, at least in part, of a suitable polymeric nonwoven fabric of synthetic fibers having hydrophobic properties.

23. The closable sample container of claim 15, characterized in that the nonwoven fabric used has a basis weight according to ISO 9073-1 of between 20 and 500 g/m2.

24. The closable sample container of claim 15, characterized in that the nonwoven fabric used has an air permeability according to ISO 9073-15 of between 30 and 4000 dm3/s m2.

25. The closable sample container of claim 15, characterized in that the nonwoven fabric used has a thickness according to FNS 19-04-04 of between 0.05 and 1.0 mm.

26. The closable sample container of claim 15, characterized in that the container has a length in a range of 1 to 30 cm and has a diameter of between 0.5 and 3 cm.

27. Use of a sample container for drying and processing of a sample of biological material comprising a cotton swab containing such a sample, wherein the sample container is comprised of a closure device and an opening closable by the closure device, suitable for transport and storage of a sample of biological material, and having at least one further opening through the wall of the closable container and the closure device, characterized in that at least one of the openings is closed or covered with a nonwoven fabric.

28. A method for processing a sample of biological material, the method comprising the following steps:
a) introducing a sample of biological material into a sample container wherein the sample container is comprised of a closure device and an opening closable by the closure device, suitable for transport and storage of a sample of biological material, and having at least one further opening through the wall of the closable container and the closure device, characterized in that at least one of the openings is closed or covered with a nonwoven fabric;
b) drying and possibly transporting the sample being in the sample container; and
c) processing the sample being in the sample container.
